(19) United States
(12) Patent Application Publication
(10) Pub. No.: US 2006/0177547 A1
(43) Pub. Date: Aug. 10, 2006

(54) Method and composition for preventing discoloration of injected beef

(76) Inventors: Arno E. Sandoval, Wildwood, MO (US); Dale A. Engelbrecht, St. Louis, MO (US); Matthew K. McMindes, Chesterfield, MO (US)

Correspondence Address: Solae, LLC;Legal Department, Building 3C, P. O. Box 88940, St. Louis, MO, 63188, US

(21) Appl. No.: 11/054,478

(22) Filed: Feb. 9, 2005

(51) Int. Cl. A23B 4/023

(52) U.S. Cl. 426/264

(57) ABSTRACT

According to the present invention, the color of beef subjected to injection is improved at the injection site with a composition, comprising; (A) a vegetable protein material and (B) an antioxidant comprising an alkali metal salt of ascorbic acid or an alkali metal salt of isoascorbic acid, wherein the vegetable protein material (A) and the antioxidant (B) are in an aqueous solution. Also disclosed is a method for using the composition.

### FIELD OF THE INVENTION

The present invention generally relates to a vegetable protein composition and method for its preparation for injection into beef. More particularly, the present invention relates to a vegetable protein composition containing an antioxidant for treating beef so that the beef remains in an unspoiled state and has a fresh appearance over an extended period of time.

### BACKGROUND OF THE INVENTION

For meats such as ham, sausage, bacon, roast pork, and meat fried products such as fried pork cutlet, a pickle solution containing soy protein is injected into the meat. Its purpose is to fortify the meat, that is, to build up the protein content of the meat. Injection also provides or increases properties of the meat as related to mouth feel, hardness, elasticity and water retention characteristics. In the method of injecting a soy protein material into the above described meats (all pork related), the injection needles upon removal cause the myoglobin in the pork product to oxidize. For pork products or poultry products (white meat), the oxidization of myoglobin is not a serious issue. The color change of the oxidized myoglobin is not significant in those meats because of the color of the base meat and also because of the concentration of the myoglobin. Table I below details meats and their varying myoglobin concentration in milligrams myoglobin per gram of meat.

TABLE I

| Meat | Myoglobin Concentration |
|---|---|
| Poultry White Muscle | 0.05 mg/g |
| Chicken Thigh | 1.8-2.0 |
| Turkey Thigh | 2.5-3.0 |
| Pork, Veal | 1.0-3.0 |
| Beef | 4.0-10.0 |
| Old Beef | 15.0-20.0 |

The oxidative state of myoglobin dictates the expressed color of fresh meat. There are three states of myoglobin: oxymyoglobin, Deoxymyoglobin, and metmyoglobin. As the name implies, oxymyoglobin is myoglobin bound to an oxygen; it is the predominant form of myoglobin in normal, brightly colored meat. Deoxymyoglobin, myoglobin that is bound to water (or with oxygen removed), has a purplish color, and is commonly seen in vacuum-packaged meat. Deoxymyoglobin readily converts to oxymyoglobin in the presence of oxygen. Metmyoglobin, the brownish color of discolored meats, results from the oxidation of the iron portion of myoglobin.

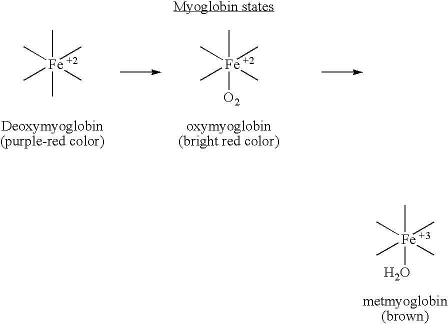

The modern consumer associates a bright red color of beef with freshness. It is well known that beef rapidly loses its bright red color after butchering and turn a brownish color under certain conditions. This brown coloration is due primarily to chemical changes of the pigment myoglobin present in the beef. In its reduced form, myoglobin imparts a purple-red color to the beef. Oxymyoglobin, which is bright red, and metmyoglobin, which is a grayish-brown color, are both obtainable from reduced myoglobin. Upon being exposed to air after the meat is cut or ground, myoglobin takes up oxygen from the air and is converted by an oxygenation process to oxymyoglobin. On the other hand, exclusion of air from the surface of the fresh cut or ground meat hastens the production of metmyoglobin with a resultant discoloration which is undesirable from the consumer's point of view. The chemistry responsible for these color changes with respect to the availability of oxygen has been well investigated by various researchers and is summarized in an article entitled, “The Chemistry of Meat Pigments”, Journal of Agricultural Food Chemistry, Vol. 14, pp. 207-10 (May-June, 1966).

When slices of freshly cut beef steaks, are stacked on top of each other during butchering, air necessarily is excluded from the adjoining surfaces and these surfaces turn a brownish color within a few hours. To alleviate this problem, it has been common practice to place sheets of porous paper between the individual slices of beef steak. The trace amounts of air trapped in the fibrous structure of such a paper interleaf apparently is sufficient to delay the formation of the undesired metmyoglobin and other discoloring pigments.

Beef that is subjected to injection also develops the brownish color due to the formation of metmyoglobin. Upon removal of the injection needles, the injection site seals itself and air is excluded from entering the injection site, thus causing the formation of metmyoglobin with the resulting brownish color. The brownish color is observed when the meat is cut into smaller pieces for display.

U.S. Pat. No. 4,056,639 (Schwarz, Nov. 1, 1977) relates to preserving the red color of fresh red meats by adding thereto a color preservative selected from the group consisting of sodium cyanate, acetylurea, sodium-5-acetylhydantoate, urethylane sodium carboxylate and mixtures thereof. In a preferred embodiment, these color preservatives are incorporated in a resinous polymeric film which is fibrillated to provide an open-celled, microporous structure having a large internal surface area. Such films can be used as an interleaf between layers of slices of freshly cut red meat and are effective for preserving the fresh color for several hours.

U.S. Pat. No. 4,818,548 (Cheng, Apr. 4, 1989) relates to a process for treating and packing fresh meat cuts so that the fresh meat color of the cuts is retained over an extended period of time generally exceeding about twenty days, and microbial deterioration and spoilage of the meat is forestalled for a period which is at least as long as the meat cuts retain the fresh meat coloration. The process involves initially treating the meat with a three component chemical composition which contains a phosphate compound, an ascorbic acid or ascorbate and a citric acid or citrate. After the cuts are treated with the aqueous solution, they are packaged in a modified gaseous atmosphere which is predominantly carbon dioxide, but also contains oxygen in a certain critical ratio to the amount of carbon dioxide employed.

U.S. Pat. No. 4,522,835 (Woodruff et al., Jun. 11, 1985) relates to establishing and maintaining good color in fresh meat, fresh poultry, and fresh fish by subjecting such meat, poultry and fish to an atmosphere containing a low oxygen concentration to convert oxymyoglobin on the surface of the meat and poultry to reduced myoglobin, and both oxymyoglobin and oxyhemoglobin in fish to reduced myoglobin/hemoglobin, respectively, then subjecting the fresh meat, fresh poultry and fresh fish to a modified atmosphere containing a small amount of carbon monoxide to convert the reduced myoglobin to carboxymyoglobin to a depth of not more than about 0.375 inch below the surface of the meat and poultry, and to convert the reduced myoglobin/hemoglobin to reduced carboxymyoglobin/carboxyhemoglobin in the fish.

U.S. Pat. No. 4,590,079 (Nishimore et al., May 20, 1986) relates to a method for preventing discoloration of meat products which comprises incorporating into meat products (a) ascorbic acids, (b) cystine and/or cysteine and (c) aspartic acid.

U.S. Pat. No. 5,540,942 (Tokoro, Jul. 30, 1996) provides a method for maintaining the freshness of meat, fish, or processed food made from meat or fish, comprising treating the meat, fish, or processed foods with ubidecarenone, and a method for maintaining the freshness of meat or fish, comprising giving ubidecarenone to an animal being bred for the production of meat or fish. The agent for maintaining the freshness comprises ubidecarenone as an active ingredient.

### SUMMARY OF THE INVENTION

According to the present invention, the color of beef subjected to injection is improved at the injection site with a composition, comprising;

(A) a vegetable protein material and

(B) an antioxidant comprising an alkali metal salt of ascorbic acid or an alkali metal salt of isoascorbic acid,

wherein the vegetable protein material (A) and the antioxidant (B) are in an aqueous solution.

Also disclosed is a method for using the composition.

Beef fortified in this manner is characterized by good color even after storage and no observable build-up of protein pockets. The vegetable protein material, when mixed with the antioxidant and water to form the inventive composition, can be injected into meats in amounts up to 125% extension.

### BRIEF DESCRIPTION OF THE DRAWINGS

FIG. 1 is a top view of an injected slice of meat that is not injected with the inventive composition.

FIG. 2 is an enlarged view of the indicated area of detail shown in FIG. 1.

FIG. 3 is a top view of an injected slice of meat that is injected with the inventive composition.

FIG. 4 is an enlarged view of the indicated area of detail shown in FIG. 3.

### DETAILED DESCRIPTION OF THE INVENTION

Definitions

As used herein the term “% extension” or its cognates is intended to mean the amount of aqueous composition (proteins, antioxidants and water) incorporated into the beef cut. When a 100 gram sample of beef is incorporated with 70 grams of aqueous composition, there is a 70% extension of the beef. When 125 grams aqueous composition is injected into the 100 gram sample of beef, there is a 125% extension.

As used herein the term “fresh beef cuts” is intended to mean beef steaks or roasts. When a cow is slaughtered, it is cut into halves or quarters which are then divided into smaller cuts such as steaks or roasts. “Fresh beef cuts” is also defined as a non-injected beef article which has not been frozen and subsequently thawed before its sale or consumption.

As used herein, the term “soy material” is defined as a material derived from whole soybeans which contains no non-soy derived additives. Such additives may, of course, be added to a soy material to provide further functionality or nutrient content in the soy material. The term “soybean” refers to the species Glycine max, Glycine soja, or any species that is sexually cross compatible with Glycine max.

The term “protein content” as used herein, refers to the relative protein content of a soy material as ascertained by A.O.C.S. (American Oil Chemists Society) Official Methods Bc 4-91(1997), Aa 5-91(1997), or Ba 4d-90(1997), each incorporated herein in its entirety by reference, which determine the total nitrogen content of a soy material sample as ammonia, and the protein content as 6.25 times the total nitrogen content of the sample.

The Nitrogen-Ammonia-Protein Modified Kjeldahl Method of A.O.C.S. Methods Bc4-91 (1997), Aa 5-91 (1997), and Ba 4d-90 (1997) used in the determination of the protein content may be performed as follows with a soy material sample. From 0.0250-1.750 grams of the soy material are weighed into a standard Kjeldahl flask. A commercially available catalyst mixture of 16.7 grams potassium sulfate, 0.6 grams titanium dioxide, 0.01 grams of copper sulfate, and 0.3 grams of pumice is added to the flask, then 30 milliliters of concentrated sulfuric acid is added to the flask. Boiling stones are added to the mixture, and the sample is digested by heating the sample in a boiling water bath for approximately 45 minutes. The flask should be rotated at least 3 times during the digestion. Three hundred milliliters of water is added to the sample, and the sample is cooled to room temperature. Standardized 0.5N hydrochloric acid and distilled water are added to a distillate receiving flask sufficient to cover the end of a distillation outlet tube at the bottom of the receiving flask. Sodium hydroxide solution is added to the digestion flask in an amount sufficient to make the digestion solution strongly alkaline. The digestion flask is then immediately connected to the distillation outlet tube, the contents of the digestion flask are thoroughly mixed by shaking, and heat is applied to the digestion flask at about a 7.5-min boil rate until at least 150 milliliters of distillate is collected. The contents of the receiving flask are then titrated with 0.25N sodium hydroxide solution using 3 or 4 drops of methyl red indicator solution—0.1% in ethyl alcohol. A blank determination of all the reagents is conducted simultaneously with the sample and similar in all respects, and correction is made for blank determined on the reagents. The moisture content of the ground sample is determined according to the procedure described below (A.O.C.S Official Method Ba 2a-38). The nitrogen content of the sample is determined according to the formula: Nitrogen (%)=1400.67×[[(Normality of standard acid)×(Volume of standard acid used for sample (ml))]−[(Volume of standard base needed to titrate 1 ml of standard acid minus volume of standard base needed to titrate reagent blank carried through method and distilled into 1 ml standard acid (ml))×(Normality of standard base)]−[(Volume of standard base used for the sample (ml))×(Normality of standard base)]]/(Milligrams of sample). The protein content is 6.25 times the nitrogen content of the sample.

The term “moisture content” as used herein refers to the amount of moisture in a material. The moisture content of a material can be determined by A.O.C.S. (American Oil Chemists Society) Method Ba 2a-38 (1997), which is incorporated herein by reference in its entirety. According to the method, the moisture content of a material may be measured by passing a 1000 gram sample of the ground material through a 6×6 riffle divider, available from Seedboro Equipment Co., Chicago, Ill., and reducing the sample size to 100 grams. The 100 gram sample is then immediately placed in an airtight container and weighed. Five grams of the sample (“Sample Weight”) are weighed onto a tared moisture dish (minimum 30 gauge, approximately 50×20 millimeters, with a tight-fitting slip cover—available from Sargent-Welch Co.). The dish containing the sample is placed in a forced draft oven and dried at 130±3° C. for 2 hours. The dish is then removed from the oven, covered immediately, and cooled in a dissector to room temperature. The dish is then weighed to obtain a Dry Weight. Moisture content is calculated according to the formula: Moisture content (%)=100×[(Sample Weight−Dry Weight)/Sample Weight].

The term “weight on a moisture free basis” as used herein refers to the weight of a material after it has been dried to completely remove all moisture, e.g. the moisture content of the material is 0%. Specifically, the weight on a moisture free basis of a soy material can be obtained by weighing the soy material after the soy material has been placed in a 45° C. oven until the soy material reaches a constant weight.

The term “soy protein isolate” as used herein is used in the sense conventional to the soy protein industry. Specifically, a soy protein isolate is a soy material having a protein content of at least 90% soy protein on a moisture free basis. “Isolated soy protein”, as used in the art, has the same meaning as “soy protein isolate” as used herein and as used in the art. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “soy protein concentrate” as used herein is used in the sense conventional to the soy protein industry. Specifically, a soy protein concentrate is a soy material having a protein content of from 65% up to 90% soy protein on a moisture-free basis. Soy protein concentrate also contains soy cotyledon fiber, typically from 3.5% to 5% soy cotyledon fiber by weight on a moisture-free basis. A soy protein concentrate is formed from soybeans by removing the hull and germ of the soybean from the cotyledon, flaking or grinding the cotyledon and removing oil from the flaked or ground cotyledon, and separating the soy protein and soy cotyledon fiber from the carbohydrates of the cotyledon.

The Vegetable Protein Material (A)

It is desirable to augment the amount of protein in beef such as a beefsteak by utilizing a vegetable protein. The vegetable protein, such as a soy protein isolate injected into the beefsteak as an aqueous solution increases the total weight of the beefsteak, or at least minimizes the weight loss within the beefsteak. An increase in total weight is due to the addition of the vegetable protein solution. Weight loss minimization is due to the aqueous vegetable protein solution forming a gel within the beefsteak such that the loss of water through evaporation, leakage or drainage is reduced. Further, vegetable protein injection increases the total amount of protein available upon consumption of the protein injected beefsteak.

Preferred vegetable protein materials useful in the composition of the present invention comprise soy protein materials or corn protein materials. Preferred proteins may also include vegetable whey proteins (i.e., non-dairy whey protein) such as the whey protein fraction generated in the soy protein process.

Soybean protein materials which are useful with the present invention are soy flour, soy concentrate, and, most preferably, soy protein isolate. The soy flour, soy concentrate, and soy protein isolate are formed from a soybean starting material which may be soybeans or a soybean derivative. Preferably the soybean starting material is either soybean cake, soybean chips, soybean meal, soybean flakes, or a mixture of these materials. The soybean cake, chips, meal, or flakes may be formed from soybeans according to conventional procedures in the art, where soybean cake and soybean chips are formed by extraction of part of the oil in soybeans by pressure or solvents, soybean flakes are formed by cracking, heating, and flaking soybeans and reducing the oil content of the soybeans by solvent extraction, and soybean meal is formed by grinding soybean cake, chips, or flakes.

The soy flour, soy concentrate and soy protein isolate are described below as containing a protein range based upon a “moisture free basis” (mfb).

Soy flour, as that term is used herein, refers to a comminuted form of defatted soybean material, preferably containing less than 1% oil, formed of particles having a size such that the particles can pass through a No. 100 mesh (U.S. Standard) screen. The soy cake, chips, flakes, meal, or mixture of the materials are comminuted into a soy flour using conventional soy grinding processes. Soy flour has a soy protein content of about 49% to about 65% on a moisture free basis (mfb). Preferably the flour is very finely ground, most preferably so that less than about 1% of the flour is retained on a 300 mesh (U.S. Standard) screen.

Soy concentrate, as the term is used herein, refers to a soy protein material containing about 65% to about 72% of soy protein (mfb). Soy concentrate is preferably formed from a commercially available defatted soy flake material from which the oil has been removed by solvent extraction. The soy concentrate is produced by an acid leaching process or by an alcohol leaching process. In the acid leaching process, the soy flake material is washed with an aqueous solvent having a pH at about the isoelectric point of soy protein, preferably at a pH of about 4.0 to about 5.0, and most preferably at a pH of about 4.4 to about 4.6. The isoelectric wash removes a large amount of water soluble carbohydrates and other water soluble components from the flakes, but removes little of the protein and fiber, thereby forming a soy concentrate. The soy concentrate is dried after the isoelectric wash. In the alcohol leaching process, the soy flake material is washed with an aqueous ethyl alcohol solution wherein ethyl alcohol is present at about 60% by weight. The protein and fiber remain insoluble while the carbohydrate soy sugars of sucrose, stachyose and raffinose are leached from the defatted flakes. The soy soluble sugars in the aqueous alcohol are separated from the insoluble protein and fiber. The insoluble protein and fiber in the aqueous alcohol phase are then dried.

Soy protein isolate, as the term is used herein, refers to a soy protein material containing at least about 90% or greater protein content, and preferably from about 92% or greater protein content (mfb). Soy protein isolate is typically produced from a starting material, such as defatted soybean material, in which the oil is extracted to leave soybean meal or flakes. More specifically, the soybeans may be initially crushed or ground and then passed through a conventional oil expeller. It is preferable, however, to remove the oil contained in the soybeans by solvent extraction with aliphatic hydrocarbons, such as hexane or azeotropes thereof, and these represent conventional techniques employed for the removal of oil. The defatted soy protein material or soybean flakes are then placed in an aqueous bath to provide a mixture having a pH of at least about 6.5 and preferably between about 7.0 and 10.0 in order to extract the protein. Typically, if it is desired to elevate the pH above 6.7, various alkaline reagents such as sodium hydroxide, potassium hydroxide and calcium hydroxide or other commonly accepted food grade alkaline reagents may be employed to elevate the pH. A pH of above about 7.0 is generally preferred, since an alkaline extraction facilitates solubilization of the protein. Typically, the pH of the aqueous extract of protein will be at least about 6.5 and preferably about 7.0 to 10.0. The ratio by weight of the aqueous extractant to the vegetable protein material is usually between about 20 to 1 and preferably a ratio of about 10 to 1. In an alternative embodiment, the vegetable protein is extracted from the milled, defatted flakes with water, that is, without a pH adjustment.

It is also desirable in obtaining the soy protein isolate used in the present invention, that an elevated temperature be employed during the aqueous extraction step, either with or without a pH adjustment, to facilitate solubilization of the protein, although ambient temperatures are equally satisfactory if desired. The extraction temperatures which may be employed can range from ambient up to about 120° F. with a preferred temperature of 90° F. The period of extraction is further non-limiting and a period of time between about 5 to 120 minutes may be conveniently employed with a preferred time of about 30 minutes. Following extraction of the vegetable protein material, the aqueous extract of protein can be stored in a holding tank or suitable container while a second extraction is performed on the insoluble solids from the first aqueous extraction step. This improves the efficiency and yield of the extraction process by exhaustively extracting the protein from the residual solids from the first step.

The combined, aqueous protein extracts from both extraction steps, without the pH adjustment or having a pH of at least 6.5, or preferably about 7.0 to 10, are then precipitated by adjustment of the pH of the extracts to, at or near the isoelectric point of the protein to form an insoluble curd precipitate. The actual pH to which the protein extracts are adjusted will vary depending upon the vegetable protein material employed but insofar as soy protein, this typically is between about 4.0 and 5.0. The precipitation step may be conveniently carried out by the addition of a common food grade acidic reagent such as acetic acid, sulfuric acid, phosphoric acid, hydrochloric acid or with any other suitable acidic reagent. The soy protein precipitates from the acidified extract, and is then separated from the extract. The separated protein may be washed with water to remove residual soluble carbohydrates and ash from the protein material and the residual acid can be neutralized to a pH of from about 4.0 to about 6.0 by the addition of a basic reagent such as sodium hydroxide or potassium hydroxide. At this point the protein material is subjected to a pasteurization step. The pasteurization step kills microorganisms that may be present. Pasteurization is carried out at a temperature of at least 180° F. for at least 10 seconds, at a temperature of at least 190° F. for at least 30 seconds or at a temperature of at least 195° F. for at least 60 seconds. The protein material is then dried using conventional drying means to form a soy protein isolate. Even though the soy protein isolate is dried and is a free flowing powder, there is a moisture content of from 4% to 5%. Soy protein isolates are commercially available from Solae® LLC, St. Louis, Mo., for example, as SUPRO® 500E, SURPO® EX 32, SUPRO® EX 33, SUPRO® 590, SUPRO® 595, SUPRO® 548, SUPRO® 248, SUPRO® SYSTEMS M9, and SUPRO® SYSTEMS M112.

Preferably the soy protein material used in the present invention, is modified to enhance the characteristics of the soy protein material. The modifications are modifications which are known in the art to improve the utility or characteristics of a protein material and include, but are not limited to, denaturation and hydrolysis of the protein material.

The soy protein material may be denatured and hydrolyzed to lower the viscosity. Chemical denaturation and hydrolysis of protein materials is well known in the art and typically consists of treating an aqueous protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing a protein material are: a pH of up to about 10, preferably up to about 9.7; a temperature of about 50° C. to about 80° C. and a time period of about 15 minutes to about 3 hours, where the denaturation and hydrolysis of the aqueous protein material occurs more rapidly at higher pH and temperature conditions.

Hydrolysis of the soy protein material may be effected by treating the protein material with an enzyme capable of hydrolyzing the protein. Many enzymes are known in the art which hydrolyze protein materials, including, but not limited to, fungal proteases, pectinases, lactases, and chymotrypsin. Enzyme hydrolysis is effected by adding a sufficient amount of enzyme to an aqueous dispersion of the protein material, typically from about 0.1% to about 10% enzyme by weight of the protein material, and treating the enzyme and protein material at a temperature, typically from about 5° C. to about 75° C., and a pH, typically from about 3 to about 9, at which the enzyme is active for a period of time sufficient to hydrolyze the protein material. After sufficient hydrolysis has occurred the enzyme is deactivated by heating to a temperature above 75° C., and the protein material is precipitated by adjusting the pH of the solution to about the isoelectric point of the protein material. Enzymes having utility for hydrolysis in the present invention include, but are not limited to, bromelain and alcalase.

The Antioxidant (B)

The compositions of this invention, as well as the components that form the compositions may be regulated by the United States Food and Drug Administration with GRAS status. GRAS means “generally recognized as safe.” Their safety is generally based on extensive toxicological test data or based on use experience for an extended period of time, but their use may be limited. It is impracticable to list all substances that are generally recognized as safe for their intended use. However, by way of illustration, such common food ingredients as salt, pepper, vinegar, baking powder and monosodium glutamate are safe for their intended use. A list of approved substances can be found in 21 CFR Parts 170 to 199, published by the Office of Federal Register National Archives and Records Administration.

All the chemicals used in this study are reagent or foodgrade materials, unless otherwise specified. The antioxidants tested are legally accepted for inclusion in food. The antioxidant (B) comprises an alkali metal salt of ascorbic acid or an alkali metal salt of isoascorbic acid, commonly referred to as erythrobic acid. The alkali metal is sodium.

In addition to the sodium salts of ascorbic acid or isoascorbic acid, the antioxidant (B) further comprises a naturally occurring or synthetic tocopherol or a phenol of the formula

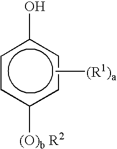

wherein R¹ is an alkyl group containing from 1 to 4 carbon atoms, R² is hydrogen or methyl, a is an integer of from 1 to 3, and b is an integer of zero or one with the proviso that when b is 1, R² is methyl. When R¹ is t-butyl, R² is methyl, a is 3, and b is 1, the antioxidant is butylated hydroxyanisole (BHA). When R¹ is t-butyl, R² is methyl, a is 2, and b is zero, the antioxidant is butylated hydroxytoluene (BHT).

Tocopherols are a member of the family of chroman compounds, and various tocopherols are known and are described in the Merck Index, 11th Edition (1989). The tocopherols described therein include alpha tocopherol, beta tocopherol, delta tocopherol, gamma tocopherol, omega tocopherol, epsilon tocopherol, etc. It is also possible in the present invention to use synthetic tocopherol compounds. The synthetic tocopherol compounds are typically obtained by alkylating the ring structure to synthetically form a chroman compound. The primary difference between synthetic and natural tocopherols is that natural tocopherols have a substantial degree of optical rotation. The synthetic tocopherols due to their formation are optically balanced in both the dextro and levo forms. Thus, the synthetic tocopherols do not exhibit optical rotation. Mixtures of tocopherols may also be used as antioxidants in the compositions of the present invention. Other antioxidants are propyl gallate, octyl gallate, trihydroxybutyrophenone (THBP), nordihydroguaiaretic acid, t-butylhydroquinone (TBHQ), gum guaiac, lecithin, and dilauryl thiodipropionate.

In preparing the compositions of this invention, an aqueous solution of the vegetable protein material (A) and the antioxidant (B) are combined together. The ratio of (A):(B) is from 90:10 to 98:2 and the aqueous solution of (A) and (B) contains from 75% to 90% water. In combining the vegetable protein material (A) and the antioxidant (B) with water, order of addition is of no consequence. The mixing temperature is from 2° F. to 15° F.

The present invention is further directed to a method for preventing discoloration of fresh beef cuts, comprising;

(A) injecting into the fresh beef cuts an aqueous solution of

(B) a vegetable protein material and

an antioxidant comprising an alkali metal salt of ascorbic acid or an alkali metal salt of isoascorbic acid.

The vegetable protein material (A) and antioxidant (B), as an aqueous composition are distributed through the fresh beef cuts by injection of the aqueous composition. Injection will distribute the aqueous composition evenly throughout the beef.

There is only one known limit for the amount of the aqueous composition that can be pumped into the beef, and that is the viscosity of the aqueous composition. The aqueous composition can be pumped as high as 125% of green weight (125% extension). The preferable limits to the amount of aqueous composition added are the limits which enables the aqueous composition to be pumped.

A high aqueous composition viscosity will make it very difficult to inject and is hard on the equipment, requiring more maintenance of the equipment, as injection needles tend to clog and injection pumps work in a stress condition. A viscous aqueous composition is more difficult to distribute and tends to accumulate in between muscle fibers and shows in the finish product as gel pockets or stretch marks.

After injection, the fresh beef cut contains from 0.8% to 1.25% on a moisture free basis of the vegetable protein (A) and from 200 parts per million to 800 parts per million on a moisture free basis of the antioxidant (B).

In the beef industry, cattle are first stunned and then bled. Next the hide is stripped from the beef carcass and the head, extremities and viscera are removed. The beef carcass is then sawed in half, thus producing two sides of beef, with each side containing half of the vertebral column and sternum, and each side being generally symmetric with the other side. After a beef carcass is split into two sides, each side is washed and then optionally pasteurized, commonly using a steam pasteurization system.

The carcass includes the following nine primal cuts of chuck, shank, brisket, rib, plate, loin, flank, sirloin, and round. These primal cuts are obtained by cutting the sides in half to obtain quarters. The quartered carcass is then further reduced to the primal cuts. Any of the above primal cuts are used in practicing this invention. Typically the primal cuts are further divided into sub-primal cuts. For example, from the beef primal loin, the following sub cuts are obtained: top loin steak, T-bone steak, porterhouse steak, tenderloin steak and sirloin steak. Injection is conducted on either a sub cut of e.g., the tenderloin or of the tenderloin after being reduced to filet mignons.

In the case of a tenderloin being the sub cut; whole, uncut tenderloins are passed through a meat injector wherein an injection solution (either a control solution or a solution of the inventive composition) is injected into the tenderloin. The tenderloin is placed on a conveyor that advances the tenderloin into an injection zone. Individual injector needles come into contact with the tenderloins. The injection needles penetrate into the tenderloin to more than half the thickness of the tenderloins. After the tenderloins leave the meat injector, they are sliced into individual fillets, weighed and stored at about 5° C. for 24 hours at which time they are weighed again to determine % weight loss. The fillets are individually vacuum packed and stored for 72 hours. After the storage period, the packages are opened and the meat is exposed to air for 2 hours. It is at this time that the fillets are observed for discoloration, i.e., the formation of metmyoglobin.

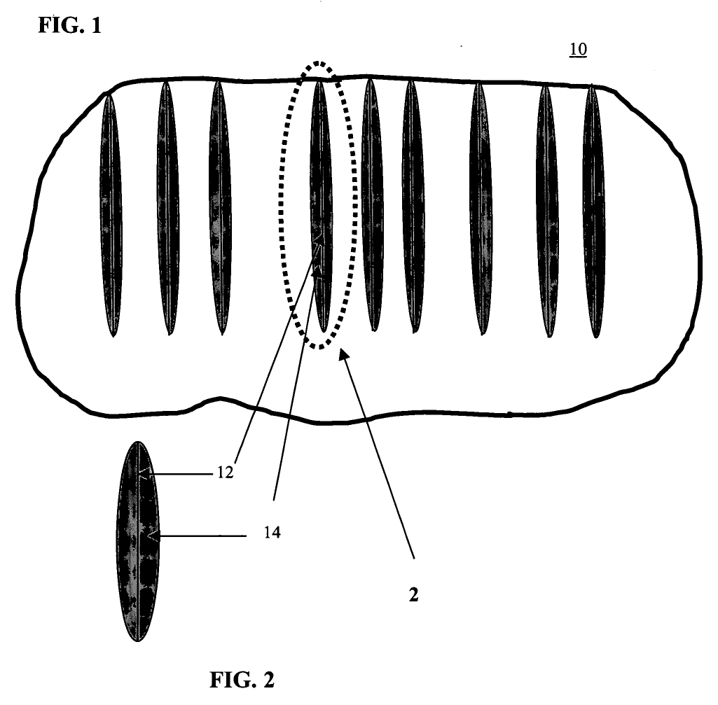

FIG. 1 illustrates an injected cut of meat 10. Injections 12 are carried forth without benefit of the inventive composition. A representative number of injections are shown in 10. It is to be understood that an actual sample of meat may have more injections than what is shown in FIG. 1. It is also to be understood that the injections may penetrate deeper or less deep than what is shown in FIG. 1. Because the inventive composition is not used, there is a discoloration 14 of the meat 10 from the injections 12.

FIG. 2 is an enlarged view of one injection site from FIG. 1 showing the discoloration 14 from the injection 12.

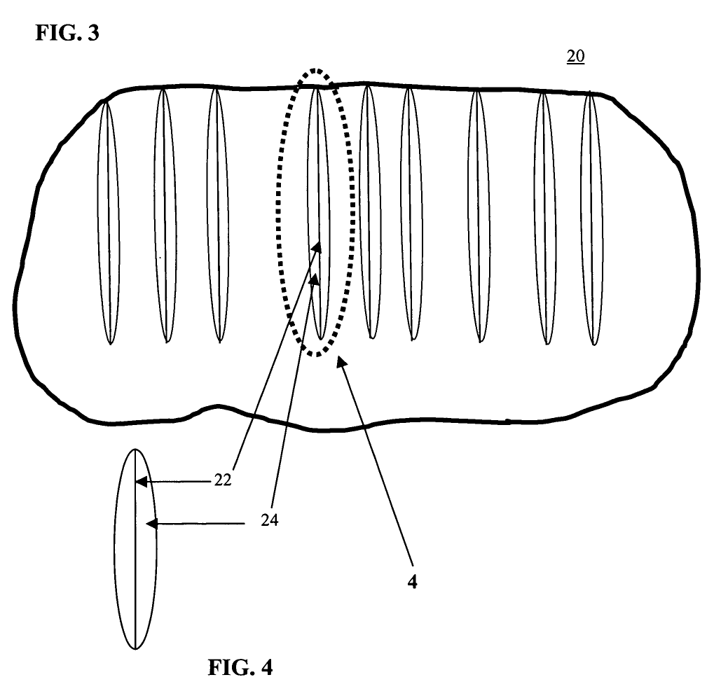

FIG. 3 illustrates an injected cut of meat 20 wherein the injections 22 are carried forth using the inventive composition. Because the inventive composition is used, there is no discoloration 24 of the meat 20 from the injections 22.

The following Control Example is illustrative of an injected piece of meat wherein the injection solution does not contain the inventive composition of the vegetable protein material (A) and the antioxidant (B).

### CONTROL EXAMPLE

A brine composition containing no antioxidant is prepared using 2.58 grams sodium chloride and 2.58 grams sodium phosphate in 94.8 grams water. The antioxidant-free brine composition is injected into a tenderloin from the beef primal loin to an extension of 114%. After 24 hours, the % weight loss of the injected meat is 4.4%. The meat is then vacuum packed and refrigerated for 72 hours. The package is opened and the meat is exposed to refrigerated air for 2 hours at which time brown discolorations are observed indicating the formation of metmyoglobin. Color is observed again at 24 hours with the discolorations being more pronounced.

The present invention is illustrated by the following examples which are merely for the purpose of illustration and not to be regarded as limiting the scope of the invention or manner in which it may be practiced.

### EXAMPLE 1

Prepared is an antioxidant composition by adding 2.64 grams sodium chloride, 3.2 grams sodium phosphate, 8.02 grams isolated soy protein identified as Supro 548, available from Solae, LLC., St. Louis, Mo. and 0.42 grams sodium erythrobate. The antioxidant brine composition is injected into a tenderloin obtained from a beef primal loin to an extension of 111%. After 24 hours, the % weight loss of the injected meat is 1.0%. The meat is then vacuum packed and refrigerated for 72 hours. The package is opened and the meat is exposed to refrigerated air for 2 hours. No brown discolorations are observed. The meat is permitted to be exposed to refrigerated air an additional at 24 hours and still no discolorations are observed, indicating no formation of metmyoglobin.

### EXAMPLE 2

Prepared is an antioxidant composition by adding 2.64 grams sodium chloride, 3.2 grams sodium phosphate, 8.02 grams isolated soy protein identified as Supro 548, available from Solae, LLC., St. Louis, Mo. and 0.42 grams sodium ascorbate. The antioxidant brine composition is injected into a tenderloin from the beef primal loin to an extension of 115%. After 24 hours, the % weight loss of the injected meat is 0.9%. The meat is then vacuum packed and refrigerated for 72 hours. The package is opened and the meat is exposed to refrigerated air for 2 hours. No brown discolorations are observed. The meat is permitted to be exposed to refrigerated air an additional at 24 hours and still no discolorations are observed, indicating no formation of metmyoglobin.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A protein composition for preventing discoloration of fresh beef cuts, comprising;
(A) a vegetable protein material and
(b) an antioxidant comprising an alkali metal salt of ascorbic acid or an alkali metal salt of isoascorbic acid,
wherein the vegetable protein material (A) and the antioxidant (B) are in an aqueous solution.

2. The composition of claim 1 wherein the vegetable protein material comprises a soybean protein material, wheat gluten or zein.

3. The composition of claim 2 wherein the soybean protein material comprises a soy flour, soy protein concentrate or soy protein isolate.

4. The composition of claim 2 wherein the soy protein isolate is a hydrolyzed soy protein isolate.

5. The composition of claim 1 wherein the alkali metal salt of isoascorbic acid is sodium erythrobate.

6. The composition of claim 1 where (B) further comprises a naturally occurring or synthetic tocopherol or a phenol of the formula 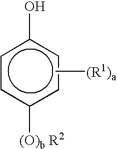
wherein R¹ is an alkyl group containing from 1 to 4 carbon atoms, R² is hydrogen or methyl, a is an integer of from 1 to 3, and b is an integer of zero or one with the proviso that when b is 1, R² is methyl.

7. The composition of claim 6 wherein R¹ is t-butyl, R² is methyl, a is 3, and b is 1.

8. The composition of claim 6 wherein R¹ is t-butyl, R² is methyl, a is 2, and b is zero.

9. The composition of claim 6 wherein the naturally occurring tocopherol comprises alpha tocopherol, beta tocopherol, delta tocopherol, gamma tocopherol, omega tocopherol, and epsilon tocopherol.

10. The composition of claim 1 wherein the ratio of A:B is from 90:10 to 98:2.

11. A method for preventing discoloration of fresh beef cuts, comprising;
injecting into the fresh beef cuts an aqueous solution of
(A) a vegetable protein material and
(B) an antioxidant comprising an alkali metal salt of ascorbic acid or an alkali metal salt of isoascorbic acid.

12. The method of claim 11 wherein the vegetable protein material comprises a soybean protein material, wheat gluten or zein.

13. The method of claim 12 wherein the soybean protein material comprises a soy flour, soy protein concentrate or soy protein isolate.

14. The method of claim 12 wherein the soy protein isolate is a hydrolyzed soy protein isolate.

15. The method of claim 11 wherein the alkali metal salt of isoascorbic acid is sodium erythrobate.

16. The method of claim 11 where (B) further comprises a naturally occurring or synthetic tocopherol or a phenol of the formula 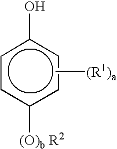
wherein R¹ is an alkyl group containing from 1 to 4 carbon atoms, R² is hydrogen or methyl, a is an integer of from 1 to 3, and b is an integer of zero or one with the proviso that when b is 1, R² is methyl.

17. The method of claim 16 wherein R¹ is t-butyl, R² is methyl, a is 3, and b is 1.

18. The method of claim 16 wherein R¹ is t-butyl, R² is methyl, a is 2, and b is zero.

19. The method of claim 11 wherein the naturally occurring tocopherol comprises alpha tocopherol, beta tocopherol, delta tocopherol, gamma tocopherol, omega tocopherol, and epsilon tocopherol.

20. The method of claim 11 wherein the ratio of A:B is from 90:10 to 98:2.

21. The method of claim 11 wherein the fresh beef cut contains from 0.8% to 1.25% on a moisture free basis of vegetable protein (A).

22. The method of claim 11 wherein the fresh beef cut contains from 200 parts per million to 800 parts per million on a moisture free basis of antioxidant (B).
